(19) United States
(12) Patent Application Publication
(10) Pub. No.: US 2025/0182010 A1
(43) Pub. Date: Jun. 5, 2025

(54) DISTRIBUTION OF INTERACTIONS BETWEEN USERS BASED ON LOAD

(71) Applicant: Samsung Electronics Co., Ltd., Suwon-si (KR)

(72) Inventor: Marc Estruch Tena, San Jose, CA (US)

(21) Appl. No.: 18/529,650

(22) Filed: Dec. 5, 2023

(51) Int. Cl. G06Q 10/0631; G06Q 10/0639

(52) U.S. Cl. CPC G06Q 10/063116; G06Q 10/063114; G06Q 10/06398

(57) ABSTRACT

A method includes obtaining one or more properties of one or more interactions associated with an agent and determining an amount of load for the agent generated by the one or more interactions based on the one or more properties of the one or more interactions. The method also includes tracking one or more changes in the one or more properties or a behavior of the agent and analyzing an effect on agent performance for the agent based on the amount of load for the agent and the one or more changes in the one or more properties or the behavior of the agent. In addition, the method includes identifying a new interaction for distribution to the agent based on analyzing agent performance data for an agent set including the agent, where the agent performance data for the agent set includes the effect on agent performance for the agent.

### TECHNICAL FIELD

This disclosure relates generally to computing or other electronic devices. More specifically, this disclosure relates to the distribution of interactions between users based on load.

### BACKGROUND

With the transition of more aspects of people's lives to virtual and remote connections, more and more tools exist that help people communicate or collaborate remotely. One example of this involves the increased use of remote customer support or remote help, which is making it possible for anyone to get help from many different physical locations without needing to go to those physical locations.

### SUMMARY

This disclosure provides for distribution of interactions between users based on load.

In a first embodiment, a method includes obtaining, using at least one processing device of an electronic device, one or more properties of one or more interactions associated with an agent. The method also includes determining, using the at least one processing device, an amount of load for the agent generated by the one or more interactions based on the one or more properties of the one or more interactions. The method further includes tracking, using the at least one processing device, one or more changes in the one or more properties or a behavior of the agent. The method also includes analyzing, using the at least one processing device, an effect on agent performance for the agent based on (i) the amount of load for the agent and (ii) the one or more changes in the one or more properties or the behavior of the agent. In addition, the method includes identifying, using the at least one processing device, a new interaction for distribution to the agent based on analyzing agent performance data for an agent set including the agent, where the agent performance data for the agent set includes the effect on agent performance for the agent.

In a second embodiment, an electronic device includes at least one processing device configured to obtain one or more properties of one or more interactions associated with an agent. The at least one processing device is also configured to determine an amount of load for the agent generated by the one or more interactions based on the one or more properties of the one or more interactions. The at least one processing device is further configured to track one or more changes in the one or more properties or a behavior of the agent. The at least one processing device is also configured to analyze an effect on agent performance for the agent based on (i) the amount of load for the agent and (ii) the one or more changes in the one or more properties or the behavior of the agent. In addition, the at least one processing device is configured to identify a new interaction for distribution to the agent based on analyzing agent performance data for an agent set including the agent, where the agent performance data for the agent set includes the effect on agent performance for the agent.

In a third embodiment, a non-transitory machine-readable medium contains instructions that when executed cause at least one processor of an electronic device to obtain one or more properties of one or more interactions associated with an agent. The non-transitory machine-readable medium also contains instructions that when executed cause the at least one processor to determine an amount of load for the agent generated by the one or more interactions based on the one or more properties of the one or more interactions. The non-transitory machine-readable medium further contains instructions that when executed cause the at least one processor to track one or more changes in the one or more properties or a behavior of the agent. The non-transitory machine-readable medium also contains instructions that when executed cause the at least one processor to analyze an effect on agent performance for the agent based on (i) the amount of load for the agent and (ii) the one or more changes in the one or more properties or the behavior of the agent. In addition, the non-transitory machine-readable medium also contains instructions that when executed cause the at least one processor to identify a new interaction for distribution to the agent based on analyzing agent performance data for an agent set including the agent, where the agent performance data for the agent set includes the effect on agent performance for the agent.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

As used here, terms and phrases such as “have,” “may have,” “include,” or “may include” a feature (like a number, function, operation, or component such as a part) indicate the existence of the feature and do not exclude the existence of other features. Also, as used here, the phrases “A or B,” “at least one of A and/or B,” or “one or more of A and/or B” may include all possible combinations of A and B. For example, “A or B,” “at least one of A and B,” and “at least one of A or B” may indicate all of (1) including at least one A, (2) including at least one B, or (3) including at least one A and at least one B. Further, as used here, the terms “first” and “second” may modify various components regardless of importance and do not limit the components. These terms are only used to distinguish one component from another. For example, a first user device and a second user device may indicate different user devices from each other, regardless of the order or importance of the devices. A first component may be denoted a second component and vice versa without departing from the scope of this disclosure.

It will be understood that, when an element (such as a first element) is referred to as being (operatively or communicatively) “coupled with/to” or “connected with/to” another element (such as a second element), it can be coupled or connected with/to the other element directly or via a third element. In contrast, it will be understood that, when an element (such as a first element) is referred to as being “directly coupled with/to” or “directly connected with/to” another element (such as a second element), no other element (such as a third element) intervenes between the element and the other element.

As used here, the phrase “configured (or set) to” may be interchangeably used with the phrases “suitable for,” “having the capacity to,” “designed to,” “adapted to,” “made to,” or “capable of” depending on the circumstances. The phrase “configured (or set) to” does not essentially mean “specifically designed in hardware to.” Rather, the phrase “configured to” may mean that a device can perform an operation together with another device or parts. For example, the phrase “processor configured (or set) to perform A, B, and C” may mean a generic-purpose processor (such as a CPU or application processor) that may perform the operations by executing one or more software programs stored in a memory device or a dedicated processor (such as an embedded processor) for performing the operations.

The terms and phrases as used here are provided merely to describe some embodiments of this disclosure but not to limit the scope of other embodiments of this disclosure. It is to be understood that the singular forms “a,” “an,” and “the” include plural references unless the context clearly dictates otherwise. All terms and phrases, including technical and scientific terms and phrases, used here have the same meanings as commonly understood by one of ordinary skill in the art to which the embodiments of this disclosure belong. It will be further understood that terms and phrases, such as those defined in commonly-used dictionaries, should be interpreted as having a meaning that is consistent with their meaning in the context of the relevant art and will not be interpreted in an idealized or overly formal sense unless expressly so defined here. In some cases, the terms and phrases defined here may be interpreted to exclude embodiments of this disclosure.

Examples of an “electronic device” according to embodiments of this disclosure may include at least one of a smartphone, a tablet personal computer (PC), a mobile phone, a video phone, an e-book reader, a desktop PC, a laptop computer, a netbook computer, a workstation, a personal digital assistant (PDA), a portable multimedia player (PMP), an MP3 player, a mobile medical device, a camera, or a wearable device (such as smart glasses, a head-mounted device (HMD), electronic clothes, an electronic bracelet, an electronic necklace, an electronic accessory, an electronic tattoo, a smart mirror, or a smart watch). Other examples of an electronic device include a smart home appliance. Examples of the smart home appliance may include at least one of a television, a digital video disc (DVD) player, an audio player, a refrigerator, an air conditioner, a cleaner, an oven, a microwave oven, a washer, a dryer, an air cleaner, a set-top box, a home automation control panel, a security control panel, a TV box (such as SAMSUNG HOMESYNC, APPLETV, or GOOGLE TV), a smart speaker or speaker with an integrated digital assistant (such as SAMSUNG GALAXY HOME, APPLE HOMEPOD, or AMAZON ECHO), a gaming console (such as an XBOX, PLAYSTATION, or NINTENDO), an electronic dictionary, an electronic key, a camcorder, or an electronic picture frame. Still other examples of an electronic device include at least one of various medical devices (such as diverse portable medical measuring devices (like a blood sugar measuring device, a heartbeat measuring device, or a body temperature measuring device), a magnetic resource angiography (MRA) device, a magnetic resource imaging (MRI) device, a computed tomography (CT) device, an imaging device, or an ultrasonic device), a navigation device, a global positioning system (GPS) receiver, an event data recorder (EDR), a flight data recorder (FDR), an automotive infotainment device, a sailing electronic device (such as a sailing navigation device or a gyro compass), avionics, security devices, vehicular head units, industrial or home robots, automatic teller machines (ATMs), point of sales (POS) devices, or Internet of Things (IoT) devices (such as a bulb, various sensors, electric or gas meter, sprinkler, fire alarm, thermostat, street light, toaster, fitness equipment, hot water tank, heater, or boiler). Other examples of an electronic device include at least one part of a piece of furniture or building/structure, an electronic board, an electronic signature receiving device, a projector, or various measurement devices (such as devices for measuring water, electricity, gas, or electromagnetic waves). Note that, according to various embodiments of this disclosure, an electronic device may be one or a combination of the above-listed devices. According to some embodiments of this disclosure, the electronic device may be a flexible electronic device. The electronic device disclosed here is not limited to the above-listed devices and may include new electronic devices depending on the development of technology.

In the following description, electronic devices are described with reference to the accompanying drawings, according to various embodiments of this disclosure. As used here, the term “user” may denote a human or another device (such as an artificial intelligent electronic device) using the electronic device.

Definitions for other certain words and phrases may be provided throughout this patent document. Those of ordinary skill in the art should understand that in many if not most instances, such definitions apply to prior as well as future uses of such defined words and phrases.

None of the description in this application should be read as implying that any particular element, step, or function is an essential element that must be included in the claim scope. The scope of patented subject matter is defined only by the claims. Moreover, none of the claims is intended to invoke 35 U.S.C. § 112(f) unless the exact words “means for” are followed by a participle. Use of any other term, including without limitation “mechanism,” “module,” “device,” “unit,” “component,” “element,” “member,” “apparatus,” “machine,” “system,” “processor,” or “controller,” within a claim is understood by the Applicant to refer to structures known to those skilled in the relevant art and is not intended to invoke 35 U.S.C. § 112 (f).

### BRIEF DESCRIPTION OF THE DRAWINGS

For a more complete understanding of this disclosure and its advantages, reference is now made to the following description taken in conjunction with the accompanying drawings, in which like reference numerals represent like parts:

FIG. 1 illustrates an example network configuration including an electronic device according to this disclosure;

FIG. 2 illustrates an example framework for distribution of interactions between agents based on load according to this disclosure;

FIG. 3 illustrates example details of an interaction processing operation in the framework of FIG. 2 according to this disclosure;

FIG. 4 illustrates example details of an interaction distribution operation in the framework of FIG. 2 according to this disclosure;

FIG. 5 illustrates example details of an agent sorting operation in the framework of FIG. 2 according to this disclosure;

FIG. 6 illustrates an example flow of data within a system using the framework of FIG. 2 according to this disclosure;

FIG. 7 illustrates example details of the system in the framework of FIG. 2 according to this disclosure;

FIG. 8 illustrates example details of the system in the framework of FIG. 2 that take into account agent skills according to this disclosure;

FIG. 9 illustrates an example framework for distribution of tasks between agents based on time prioritization according to this disclosure; and

FIG. 10 illustrates an example method for distribution of interactions between agents based on load according to this disclosure.

### DETAILED DESCRIPTION

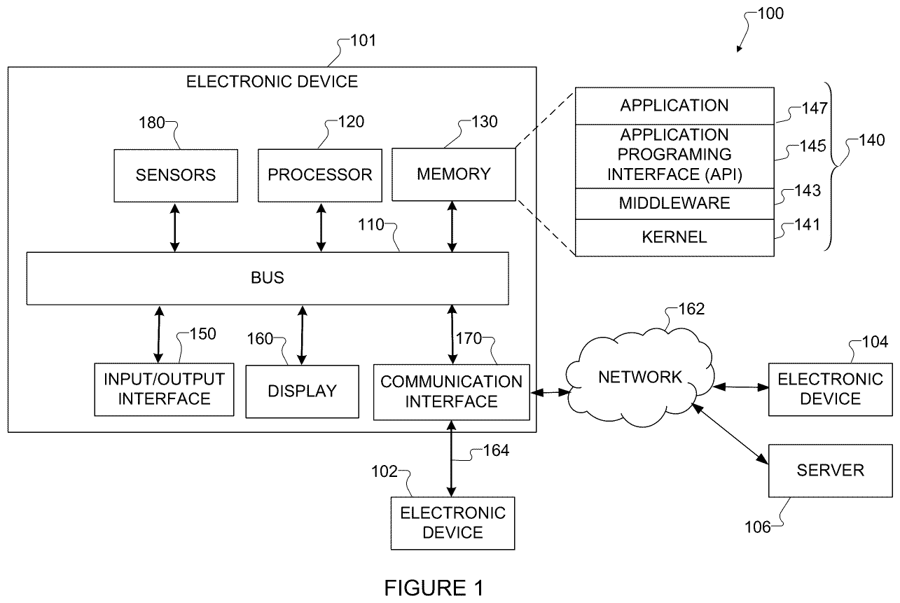

FIGS. 1 through 10, discussed below, and the various embodiments of this disclosure are described with reference to the accompanying drawings. However, it should be appreciated that this disclosure is not limited to these embodiments and all changes and/or equivalents or replacements thereto also belong to the scope of this disclosure.

As discussed above, with the transition of more aspects of people's lives to virtual and remote connections, more and more tools exist that help people communicate or collaborate remotely. One example of this involves the increased use of remote customer support or remote help, which is making it possible for anyone to get help from many different physical locations without needing to go to those physical locations. For example, remote interactions have opened possibilities for remote agents to perform multi-tasking in a different way than in-person interactions permit. Additionally, remote interactions may involve a different amount of agent attention (also referred to as cognitive load). For instance, tasks that can be very simple in person (such as identifying why a television is not turning on) can become tedious when performed remotely. On the other hand, tasks that can be difficult in person (such as having three conversations at once with three text chats) can be simpler to manage remotely.

At physical location points of contact, customers may need to wait for an agent to be available, and customers' interactions with agents are often limited to one-on-one interactions (meaning one customer per agent). For example, an agent in a physical location (such as a customer service representative in a store) can typically only interact face-to-face with one customer at a time. However, with remote customer support, the number of interactions an agent might be able to handle can be more than one. For instance, an online representative may be able to remotely “chat,” via a text-based chat box, with multiple customers at a time.

Also, distribution of interactions among agents can be different for various remote customer support environments and can also differ based on the types of interactions (such as video conferencing, voice calling, text chatting, screen-sharing, or the like). This is because different interactions can involve a different amount of attention by a representative or agent. For example, while a particular online representative may be able to remotely text chat with three or four customers concurrently, the same online representative might have difficulty engaging in more than one video conference with different customers at the same time. In addition, interactions of the same type might involve different amounts of attention depending on what occurs in those interactions specifically. For example, not all text chats involve the same amount of attention by an agent, and (depending on the subject matter) two complex interactions can be more consuming of the representative's resources than four simple interactions.

Each agent may have different capacities at which the agent can perform different tasks at a good performance level. This becomes more apparent when multi-tasking and remote interactions are added into the agent's workload. For example, an agent might be able to handle three text interactions that take only 75% of the agent's cognitive load. However, a single text interaction plus a screen share might consume 90% of the agent's cognitive load. If another interaction, even a simple text interaction, is added to the agent's tasks, this might total more than 100% of the agent's cognitive load, which can lead to reduced performance by the agent.

In systems where multiple agents can communicate remotely with customers or clients using different types of interactions (such as video, voice, text, file-sharing, drawings, and the like) and a limited number of agents need to be able to handle multiple interactions per agent, it can be useful or desirable to strategically distribute the interactions among the different agents. This becomes especially important when performance needs to be maintained at a high level. For this reason, it can be useful or desirable to manage new interactions so that the combined load of all interactions is distributed appropriately among all available agents and their capacities.

This disclosure provides various techniques for distribution of interactions between users based on load. As described in more detail below, the disclosed embodiments understand and track how much load different interactions create for a specific agent, taking into account the type of the interaction and tracking how type and agent behavior may change over time. The disclosed embodiments also process and understand different load requirements from different interactions to determine how the interactions affect agent performance. In addition, the disclosed embodiments may process all interactions within a system and distribute any new interactions to an appropriate agent in order to ensure a distributed effort among the different agents of the system.

Note that while some of the embodiments discussed below are described in the context of use by various consumer electronic devices (such as smartphones or computers), this is merely one example. It will be understood that the principles of this disclosure may be implemented in any number of other suitable contexts and may use any suitable devices.

FIG. 1 illustrates an example network configuration 100 including an electronic device according to this disclosure. The embodiment of the network configuration 100 shown in FIG. 1 is for illustration only. Other embodiments of the network configuration 100 could be used without departing from the scope of this disclosure.

According to embodiments of this disclosure, an electronic device 101 is included in the network configuration 100. The electronic device 101 can include at least one of a bus 110, a processor 120, a memory 130, an input/output (I/O) interface 150, a display 160, a communication interface 170, or a sensor 180. In some embodiments, the electronic device 101 may exclude at least one of these components or may add at least one other component. The bus 110 includes a circuit for connecting the components 120-180 with one another and for transferring communications (such as control messages and/or data) between the components.

The processor 120 includes one or more processing devices, such as one or more microprocessors, microcontrollers, digital signal processors (DSPs), application specific integrated circuits (ASICs), or field programmable gate arrays (FPGAs). In some embodiments, the processor 120 includes one or more of a central processing unit (CPU), an application processor (AP), a communication processor (CP), or a graphics processor unit (GPU). The processor 120 is able to perform control on at least one of the other components of the electronic device 101 and/or perform an operation or data processing relating to communication or other functions. As described in more detail below, the processor 120 may perform one or more operations for distribution of interactions between users based on load.

The memory 130 can include a volatile and/or non-volatile memory. For example, the memory 130 can store commands or data related to at least one other component of the electronic device 101. According to embodiments of this disclosure, the memory 130 can store software and/or a program 140. The program 140 includes, for example, a kernel 141, middleware 143, an application programming interface (API) 145, and/or an application program (or “application”) 147. At least a portion of the kernel 141, middleware 143, or API 145 may be denoted an operating system (OS).

The kernel 141 can control or manage system resources (such as the bus 110, processor 120, or memory 130) used to perform operations or functions implemented in other programs (such as the middleware 143, API 145, or application 147). The kernel 141 provides an interface that allows the middleware 143, the API 145, or the application 147 to access the individual components of the electronic device 101 to control or manage the system resources. The application 147 may support one or more functions for distribution of interactions between users based on load as discussed below. These functions can be performed by a single application or by multiple applications that each carry out one or more of these functions. The middleware 143 can function as a relay to allow the API 145 or the application 147 to communicate data with the kernel 141, for instance. A plurality of applications 147 can be provided. The middleware 143 is able to control work requests received from the applications 147, such as by allocating the priority of using the system resources of the electronic device 101 (like the bus 110, the processor 120, or the memory 130) to at least one of the plurality of applications 147. The API 145 is an interface allowing the application 147 to control functions provided from the kernel 141 or the middleware 143. For example, the API 145 includes at least one interface or function (such as a command) for filing control, window control, image processing, or text control.

The I/O interface 150 serves as an interface that can, for example, transfer commands or data input from a user or other external devices to other component(s) of the electronic device 101. The I/O interface 150 can also output commands or data received from other component(s) of the electronic device 101 to the user or the other external device.

The display 160 includes, for example, a liquid crystal display (LCD), a light emitting diode (LED) display, an organic light emitting diode (OLED) display, a quantum-dot light emitting diode (QLED) display, a microelectromechanical systems (MEMS) display, or an electronic paper display. The display 160 can also be a depth-aware display, such as a multi-focal display. The display 160 is able to display, for example, various contents (such as text, images, videos, icons, or symbols) to the user. The display 160 can include a touchscreen and may receive, for example, a touch, gesture, proximity, or hovering input using an electronic pen or a body portion of the user.

The communication interface 170, for example, is able to set up communication between the electronic device 101 and an external electronic device (such as a first electronic device 102, a second electronic device 104, or a server 106). For example, the communication interface 170 can be connected with a network 162 or 164 through wireless or wired communication to communicate with the external electronic device. The communication interface 170 can be a wired or wireless transceiver or any other component for transmitting and receiving signals.

The wireless communication is able to use at least one of, for example, Wi-Fi, long term evolution (LTE), long term evolution-advanced (LTE-A), 5th generation wireless system (5G), millimeter-wave or 60 GHz wireless communication, Wireless USB, code division multiple access (CDMA), wideband code division multiple access (WCDMA), universal mobile telecommunication system (UMTS), wireless broadband (WiBro), or global system for mobile communication (GSM), as a communication protocol. The wired connection can include, for example, at least one of a universal serial bus (USB), high definition multimedia interface (HDMI), recommended standard 232 (RS-232), or plain old telephone service (POTS). The network 162 or 164 includes at least one communication network, such as a computer network (like a local area network (LAN) or wide area network (WAN)), Internet, or a telephone network.

The electronic device 101 may further include one or more sensors 180 that can meter a physical quantity or detect an activation state of the electronic device 101 and convert metered or detected information into an electrical signal. For example, one or more sensors 180 can include one or more cameras or other imaging sensors for capturing images of scenes. The sensor(s) 180 can also include one or more buttons for touch input, a gesture sensor, a gyroscope or gyro sensor, an air pressure sensor, a magnetic sensor or magnetometer, an acceleration sensor or accelerometer, a grip sensor, a proximity sensor, a color sensor (such as a red green blue (RGB) sensor), a bio-physical sensor, a temperature sensor, a humidity sensor, an illumination sensor, an ultraviolet (UV) sensor, an electromyography (EMG) sensor, an electroencephalogram (EEG) sensor, an electrocardiogram (ECG) sensor, an infrared (IR) sensor, an ultrasound sensor, an iris sensor, or a fingerprint sensor. The sensor(s) 180 can further include an inertial measurement unit, which can include one or more accelerometers, gyroscopes, and other components. In addition, the sensor(s) 180 can include a control circuit for controlling at least one of the sensors included here. Any of these sensor(s) 180 can be located within the electronic device 101.

In some embodiments, the electronic device 101 can be a wearable device or an electronic device-mountable wearable device (such as an HMD). For example, the electronic device 101 may represent an AR wearable device, such as a headset with a display panel or smart eyeglasses. In other embodiments, the first external electronic device 102 or the second external electronic device 104 can be a wearable device or an electronic device-mountable wearable device (such as an HMD). In those other embodiments, when the electronic device 101 is mounted in the electronic device 102 (such as the HMD), the electronic device 101 can communicate with the electronic device 102 through the communication interface 170. The electronic device 101 can be directly connected with the electronic device 102 to communicate with the electronic device 102 without involving a separate network.

The first and second external electronic devices 102 and 104 and the server 106 each can be a device of the same or a different type from the electronic device 101. According to certain embodiments of this disclosure, the server 106 includes a group of one or more servers. Also, according to certain embodiments of this disclosure, all or some of the operations executed on the electronic device 101 can be executed on another or multiple other electronic devices (such as the electronic devices 102 and 104 or server 106). Further, according to certain embodiments of this disclosure, when the electronic device 101 should perform some function or service automatically or at a request, the electronic device 101, instead of executing the function or service on its own or additionally, can request another device (such as electronic devices 102 and 104 or server 106) to perform at least some functions associated therewith. The other electronic device (such as electronic devices 102 and 104 or server 106) is able to execute the requested functions or additional functions and transfer a result of the execution to the electronic device 101. The electronic device 101 can provide a requested function or service by processing the received result as it is or additionally. To that end, a cloud computing, distributed computing, or client-server computing technique may be used, for example. While FIG. 1 shows that the electronic device 101 includes the communication interface 170 to communicate with the external electronic device 104 or server 106 via the network 162 or 164, the electronic device 101 may be independently operated without a separate communication function according to some embodiments of this disclosure.

The server 106 can include the same or similar components 110-180 as the electronic device 101 (or a suitable subset thereof). The server 106 can support to drive the electronic device 101 by performing at least one of operations (or functions) implemented on the electronic device 101. For example, the server 106 can include a processing module or processor that may support the processor 120 implemented in the electronic device 101. As described in more detail below, the server 106 may perform one or more operations to support techniques for distribution of interactions between users based on load.

Although FIG. 1 illustrates one example of a network configuration 100 including an electronic device 101, various changes may be made to FIG. 1. For example, the network configuration 100 could include any number of each component in any suitable arrangement. In general, computing and communication systems come in a wide variety of configurations, and FIG. 1 does not limit the scope of this disclosure to any particular configuration. Also, while FIG. 1 illustrates one operational environment in which various features disclosed in this patent document can be used, these features could be used in any other suitable system.

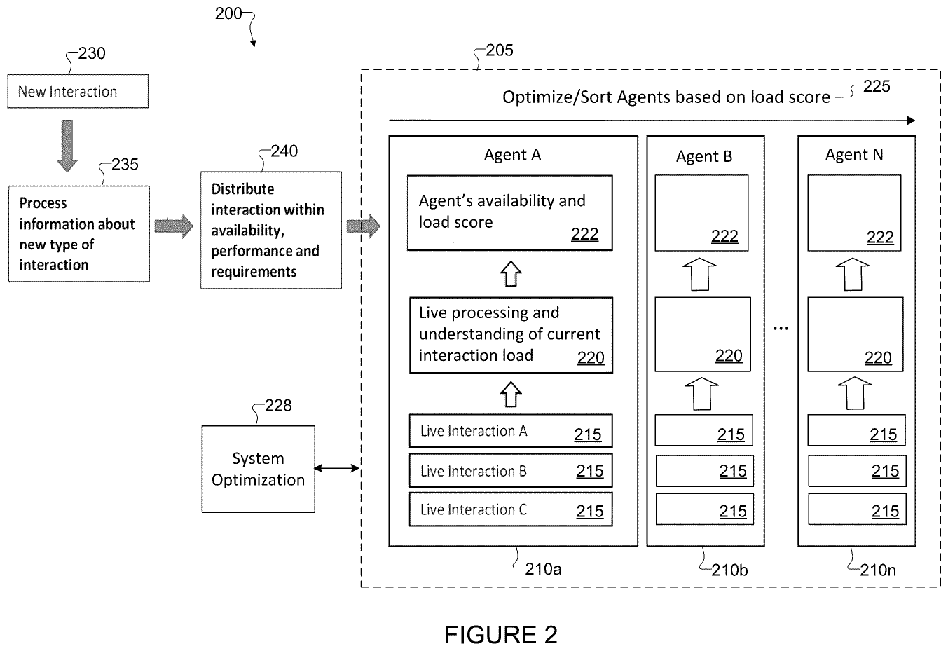

FIG. 2 illustrates an example framework 200 for distribution of interactions between agents based on load according to this disclosure. For ease of explanation, the framework 200 is described as being implemented using one or more components of the network configuration 100 of FIG. 1 described above, such as one or more instances of the electronic device 101 and/or the server 106. However, this is merely one example, and the framework 200 could be implemented using any other suitable device(s) and in any other suitable system(s).

As shown in FIG. 2, the framework 200 includes an agent interaction system 205 that handles the processing of interactions by agents 210a-210n, who are users of the system 205. In FIG. 2, the agents 210a-210n are part of an agent set that includes N agents, who are identified as “Agent A,” “Agent B,” . . . , “Agent N.” Here, N can be any suitable positive integer greater than one and possibly much greater than one. In some embodiments, the agents 210a-210n in the agent set are customer support agents, representatives, or advisors that handle online interactions with customers or clients. Of course, this is merely one example. In other embodiments, the agents 210a-210n could handle other types of interactions with other types or categories of people.

Each agent 210a-210n handles one or more live interactions 215 with one or more customers or clients. Each interaction 215 can include a text chat, a video conference, a voice call, screen-sharing, an online search, other suitable interaction modes, or any combination of two or more of these. The interactions 215 for each agent 210a-210n can occur concurrently, meaning that (i) an agent 210a-210n can have at least one active user interface open on his or her computer for each interaction 215 and (ii) the agent 210a-210n devotes at least some attention or cognitive load to each interaction 215 during a short time period. As described in greater detail below, the number(s) and type(s) of interactions 215 currently handled by each agent 210a-210n is managed by the system 205. While FIG. 2 shows each agent 210a-210n handling three interactions 215, this is merely an example. Each agent 210a-210n may be able to handle more or fewer than three interactions 215, and the number of interactions 215 handled by each agent 210a-210n can be different among the agents 210a-210n.

While each agent 210a-210n handles his or her interactions 215, the system 205 performs an operation 220 in which the system 205 obtains measurable parameters or metrics about each agent 210a-210n and monitors the interactions 215 currently handled by each agent 210a-210n. The system 205 processes the parameters to determine the current interaction load for each agent 210a-210n as a result of the interactions 215. The system performs the operation 220 repeatedly or continuously while each agent 210a-210n works in order to determine the agent's current availability and track changes in the properties of the interactions 215 or the behavior of each agent 210a-210n. The information generated in the operation 220 is also helpful for the system 205 to understand the behavior of each agent 210a-210n in response to different interactions 215 assigned to that agent 210a-210n. For example, the system 205 could determine if having several interactions 215 at once might negatively affect the performance of a specific agent 210a-210n.

The system 205 can use the tracked interactions 215, the current cognitive load information of each agent 210a-210n, the metrics obtained in the operation 220, and any system requirements to determine a load score 222 for each agent 210a-210n. In some embodiments, each load score 222 can include a normalized load score of each interaction 215 for that agent 210a-210n. Each load score 222 for an agent 210a-210n can vary over time based on new information obtained by the system 205 about the interactions 215. As discussed in greater detail below, the system 205 also performs an operation 225 in which the agents 210a-210n are sorted or optimized based on their load scores 222 in order to better assign agents 210a-210n to interactions 215 or to better assign interactions 215 to agents 210a-210n. In addition, the system 205 regularly performs a system optimization operation 228, which is described in greater detail below.

When a new interaction 230 is introduced into the system 205 (such as when a customer initiates a request for help from an agent 210a-210n), the system 205 performs an operation 235 in which the system 205 processes information about the new interaction 230, such as one or more properties of the new interaction 230, in order to integrate the new interaction 230 into the system 205. Here, the one or more properties can include the type of interaction (such as text chat, video, and the like). In some embodiments, the customer initiates the request for help while interacting with a customer support interface, such as a product website, a company help page, an application (“app”) installed on a customer's phone or computer, a point-of-sale kiosk, or the like.

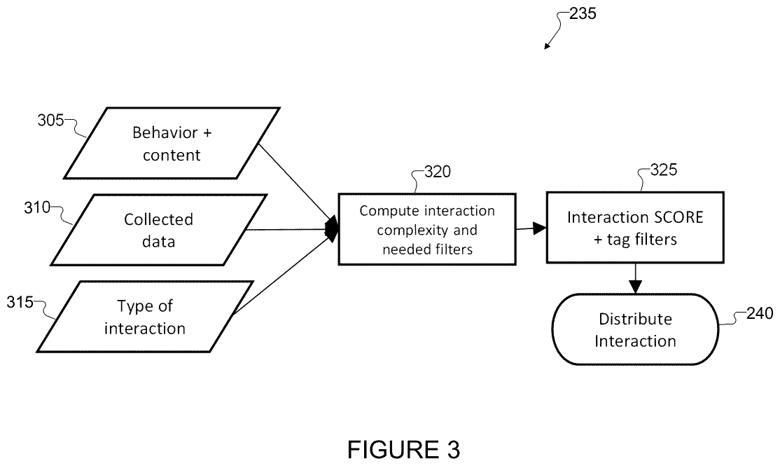

FIG. 3 illustrates example details of an interaction processing operation (the operation 235) in the framework 200 of FIG. 2 according to this disclosure. As shown in FIG. 3, the system 205 obtains various properties about the new interaction 230 while the customer interacts with the customer support interface, such as customer behavior and content information 305, customer collected data 310, and type of interaction 315.

The system 205 can obtain the customer behavior and content information 305 by tracking the customer's behavior in the customer support interface as well as content being displayed in the customer support interface in order to understand a possible conversation topic and handling difficulty. In some embodiments, the system 205 can generate one or more tags that relate to where the customer is (such as what device and interface the customer is using) while interacting with the customer support interface. The system 205 can also track the duration of the customer's interaction in the customer support interface as well as the customer's navigation behaviors, which can be included in the customer behavior and content information 305. Such information can be used to identify possible topics of customer interest or erratic behavior, which can suggest customer confusion or difficulty in trying to find information in the customer support interface. This information can be used to generate more specific tags or a score indicating a customer's possible knowledge of a subject. The customer behavior and content information 305 can also include behavior of the customer prior to initiating the new interaction 230. For example, the behavior of the customer can include the customer searching for an owner's manual, troubleshooting a problem, shopping for a new purchase, or the like.

The customer collected data 310 includes information that may have been collected by the system 205 from the customer, such as a specific topic that the customer wishes to discuss. In some embodiments, the customer collected data 310 can be obtained by user selection in the customer support interface, obtained by a chatbot or an input field, and the like. As one example, a customer could pre-select a type of appliance (such as a refrigerator) in the customer support interface and input information specific for that type of appliance (such as trouble with a broken light). Another example of customer collected data 310 includes transaction-related information, such as a purchase order, receipt, extended warranty, and the like. The customer collected data 310 can be used by the system 205 to improve determination of customer intention and filtering.

The type of interaction 315 represents the interaction type desired by the customer for the new interaction 230. This could include, for example, the customer indicating that the customer would like to start a text chat, a voice call, a video conference, or the like. The different types of interaction 315 can have different levels of complexity and can require different amounts of attention or cognitive load by an agent 210a-210n.

Once the system 205 obtains the customer behavior and content information 305, the customer collected data 310, and the type of interaction 315, the system 205 can perform an operation 320 in which the system 205 computes the complexity of the new interaction 230 and determines any tag filters (if needed). In some embodiments, the complexity of the new interaction 230 can be represented as an interaction score 325. Also, in some embodiments, the system 205 can implement one or more machine learning (ML) or artificial intelligence (AI) algorithms or routines to compute the complexity of the new interaction 230, generate the interaction score 325, and determine any tag filters.

Turning again to FIG. 2, based on the processed information about the new interaction 230, the system 205 performs an operation 240 in which the system 205 distributes the new interaction 230 by assigning the new interaction 230 to one of the agents 210a-210n. The new interaction 230 may be distributed to a “best” (such as a most suitable) agent 210a-210n based on the availability of the agents 210a-210n, performance of the agents 210a-210n (such as determined by the agent's load score 222), requirements of the new interaction 230, or a combination of two or more of these. In some embodiments, distributing the new interaction 230 can include pausing the new interaction 230 (such as putting the new interaction 230 in a wait queue) until a suitable agent 210a-210n is available if one is not currently available at the time the new interaction 230 is introduced.

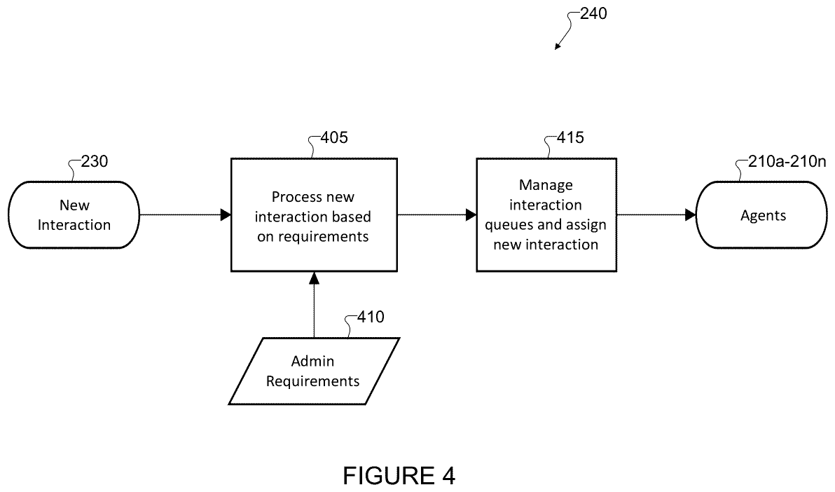

FIG. 4 illustrates example details of an interaction distribution operation (the operation 240) in the framework 200 of FIG. 2 according to this disclosure. As shown in FIG. 4, the system 205 obtains the new interaction 230 as an input to the operation 240. The system 205 considers the status of the system 205 (such as the availability of the agents 210a-210n and their skill levels) and the requirements for handling the new interaction 230 and uses that information to distribute the new interaction 230 within the system 205.

At an operation 405, the system 205 processes the new interaction 230 based on one or more requirements associated with the new interaction 230. The requirements can include the type of the new interaction 230, the load level of the new interaction 230, and one or more administrative (“admin”) requirements 410. Here, the administrative requirements 410 can include various rules, parameters, and requirements that are managed by a system administrator for processing of incoming and existing interactions. An example administrative requirement 410 may be that interactions of a certain type (such as refrigerator troubleshooting) can only be handled by a specified group of agents 210a-210n.

At an operation 415, the system 205 assigns the new interaction 230 to an agent 210a-210n based on the requirements for the new interaction 230 and the availability and skills of the agents 210a-210n. If an agent 210a-210n is not currently available for the new interaction 230, the system 205 can assign the new interaction 230 to an interaction queue, where the new interaction 230 can be assigned once a suitable agent 210a-210n is available. The operation 415 can also include managing other new interactions 230 that may already be in an interaction queue and assigning such new interactions 230 once agents 210a-210n are available. Once assigned to an agent 210a-210n, the new interaction 230 becomes one of the live interactions 215 for that agent 210a-210n.

By understanding how complex each interaction 215 is and the requirements for each interaction 215 and by understanding how each agent 210a-210n is able to handle different interactions 215 (both individually and concurrently), the system 205 can better distribute the different interactions 215 in order to maintain maximum overall performance of the agents 210a-210n and provide the best service to customers. This understanding can include determining how much attention an interaction 215 requires by an agent 210a-210n so that the system 205 can determine how much availability an agent 210a-210n might have at a specific time and maximize that agent's cognitive performance.

As discussed above, the system 205 performs the operation 225 in which the agents 210a-210n are sorted or optimized based on their load scores 222 in order to better assign agents 210a-210n to interactions 215 or to better assign interactions 215 to agents 210a-210n. The operation 225 can be performed regularly or continuously in order to maintain the agents 210a-210n in a sorted or optimized arrangement based on the agents' load scores 222, which can reflect each agent's current load, available load, skill levels, and the like.

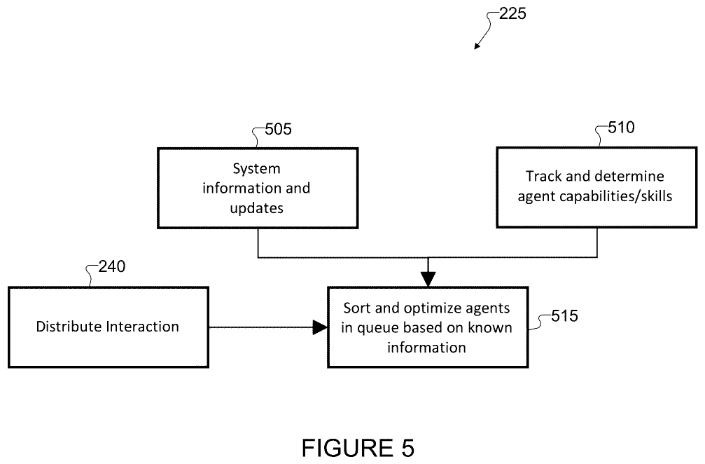

FIG. 5 illustrates example details of an agent sorting operation (the operation 225) in the framework 200 of FIG. 2 according to this disclosure. As shown in FIG. 5, the system 205 regularly obtains system information 505, which includes status information in the system 205. Examples of status information may include the overall current system load, which agents 210a-210n are busier than others, how busy the system 205 is at different times of the day, and the like. In addition, the system 205 regularly tracks and determines the capabilities, skills, and behavior of each agent 210a-210n at an operation 510. Agent skill and capability information can change over time as each agent 210a-210n goes through training, different products are introduced, and the like. Likewise, agent behavior can change in response to changes in skill and capability and changes in handled the interactions 215. The system 205 can also analyze the effects on the performance of each agent 210a-210n based on the amount of load for each agent 210a-210n, changes in properties of the interactions 215, or the behavior of each agent 210a-210n.

With the system update information 505 and the capabilities information for each agent 210a-210n, the system 205 can optimize the agent set by creating a pre-sorted queue of the different agents 210a-210n at an operation 515. The queue can be used for quickly determining suitable agents 210a-210n to which to assign new interactions 230 as they are generated, such as in the operation 240. Once a new interaction 230 is assigned to an agent 210a-210n, the system 205 can update the queue of sorted agents 210a-210n to reflect the fact that an agent 210a-210n is now handling another interaction 215. The use of an optimized queue of sorted agents 210a-210n is very helpful in reducing comparisons in large systems where hundreds or thousands of interactions 215 are handled concurrently by hundreds of agents 210a-210n.

Given the load scores 222 for the agents 210a-210n, the overall group of interactions 215, the metrics obtained in the operation 220, and any system requirements, the system 205 regularly performs the system optimization operation 228 to keep the system 205 current with the latest load information. This can include determining a load score 222 for each interaction 215, which is a measure of how much computing power and agent attention is required for a specific interaction 215. Interaction load scores enable the system 205 to optimize the overall system's computing power when there are hundreds of simultaneous interactions 215. Here, the required computing power can also refer to various computing or technological functions that might be needed to handle interactions, such as computer vision, transcription, tracking, and the like.

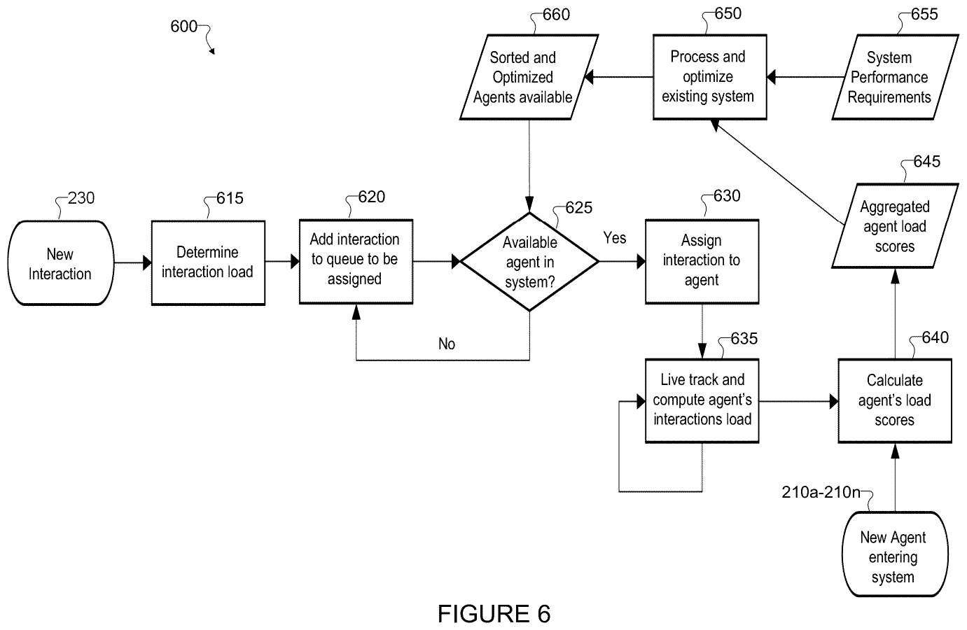

FIG. 6 illustrates an example flow 600 of data within the system 205 using the framework 200 according to this disclosure. As shown in FIG. 6, new data enters the system 205 via a new interaction 230 or a new agent 210a-210n connecting to the system 205. For a new interaction 230, the load of the new interaction 230 is computed at an operation 615. At an operation 620, the new interaction 230 is added to a queue to be assigned. At an operation 625, the system 205 determines if there is an available agent 210a-210n to handle the new interaction 230. If an agent 210a-210n is available, at an operation 630, the new interaction 230 is assigned to the available agent 210a-210n. If an agent 210a-210n is not available, the new interaction 230 waits in the queue.

At an operation 635, the system 205 tracks the agents 210a-210n, the interactions 215, and the interaction load of each agent 210a-210n. This can be continuous and can be updated as changes occur within the system 205. At an operation 640, the system 205 calculates the load scores 222 of the agents 210a-210n. At an operation 645, the system 205 aggregates the load scores 222. In some cases, if a new agent 210a-210n is added to the system 205, the new agent 210a-210n can have no history or load score 222, so there may be nothing to aggregate for that agent 210a-210n.

At an operation 650, the system 205 processes and optimizes the system 205 using the load scores 222 of the agents 210a-210n and any system performance requirements 655. In some embodiments, the system performance requirements 655 can include any overall requirements that can affect the performance of the system 205 or the agents 210a-210n in handling the interactions 215. For example, a system performance requirement 655 can be that no agent 210a-210n can handle more than two text chats simultaneously. The optimized system information can include a sorted and optimized queue 660 of available agents 210a-210n that can be referred to when determining an available agent 210a-210n in the operation 625.

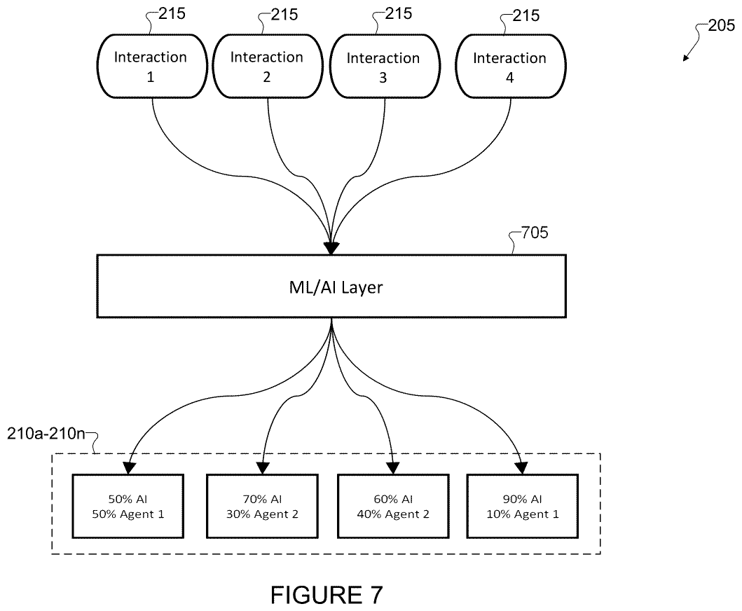

FIG. 7 illustrates example details of the system 205 in the framework 200 of FIG. 2 according to this disclosure. As shown in FIG. 7, some embodiments of the system 205 can include an ML/AI layer 705 that operates between the agents 210a-210n and the interactions 215, which can significantly increase the capabilities of each agent 210a-210n. The ML/AI layer 705 includes one or more ML or AI algorithms, routines, or networks (such as one or more large language models, neural networks, and the like) that are trained to handle routine aspects of the interactions 215 on behalf of the agents 210a-210n. For example, the ML/AI layer 705 could handle any boilerplate conversations and conversation fillings between the agents 210a-210n and their customers. Using natural language processing or other suitable techniques, the ML/AI layer 705 can interact with a customer while appearing to the customer as though the conversation is with a human agent 210a-210n. This enables the agents 210a-210n to simply complete empty fields in boilerplate conversations (“fill in the blanks”) as needed to complete content of an interaction 215 assigned to the agent 210a-210n.

In some embodiments, the ML/AI layer 705 can track the quality of its own performance and, based on performance results, change the amount of attention needed by the agent 210a-210n versus work performed by the ML/AI layer 705 for a specific interaction 215. For example, in some cases, the ML/AI layer 705 might be able to handle 50% of one particular type of interaction 215 and may be able to handle 90% of another type of interaction 215. These balances can change over time as the capabilities of the agents 210a-210n and the ML/AI layer 705 change. Moreover, in some embodiments, using the data collected over time as the agents 210a-210n handle the interactions 215, the ML/AI layer 705 can be trained to expand its knowledge base and capabilities to handle more types of interactions 215. Among other things, this may leave more advanced or complex interactions 215 to the human agents 210a-210n.

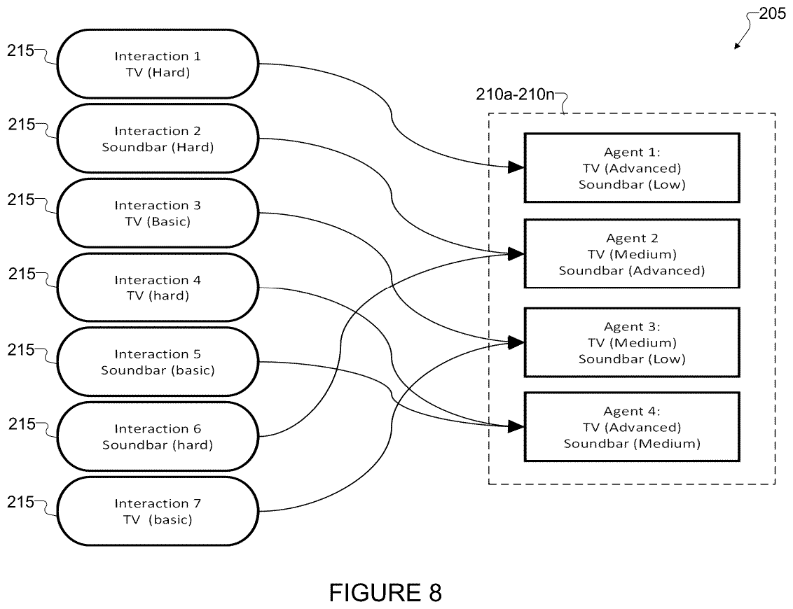

FIG. 8 illustrates example details of the system 205 in the framework 200 of FIG. 2 that take into account agent skills according to this disclosure. As shown in FIG. 8, the system 205 can assign interactions 215 to agents 210a-210n based on the skills or content knowledge of each agent 210a-210n. In some embodiments, the system 205 keeps track of each agent's performance to determine an agent's skills or content knowledge. These skills or content knowledge can be regularly updated over time and applied when the system 205 assigns interactions 215 to agents 210a-210n. For example, the system 205 can determine a subject matter for each interaction 215 (such as television or soundbar) and a complexity level for that interaction 215 (such as basic or hard) and match that information to an agent 210a-210n that is more skilled for such an interaction. As a particular example, in FIG. 8, Agent 1 has advanced skills for television troubleshooting but low skills for soundbar troubleshooting. Thus, Interaction 1, which is related to a television issue that may be difficult or complex to resolve, can be assigned to Agent 1.

Although FIGS. 2 through 8 illustrate one example of a framework 200 for distribution of interactions between agents based on load and related details, various changes may be made to FIGS. 2 through 8. For example, while the system 205 is described as performing specific sequences of operations, various operations described with respect to FIGS. 2 through 8 could overlap, occur in parallel, occur in a different order, or occur any number of times (including zero times). Also, the specific operations shown in FIGS. 2 through 8 are examples only, and other techniques could be used to perform each of the operations shown in FIGS. 2 through 8.

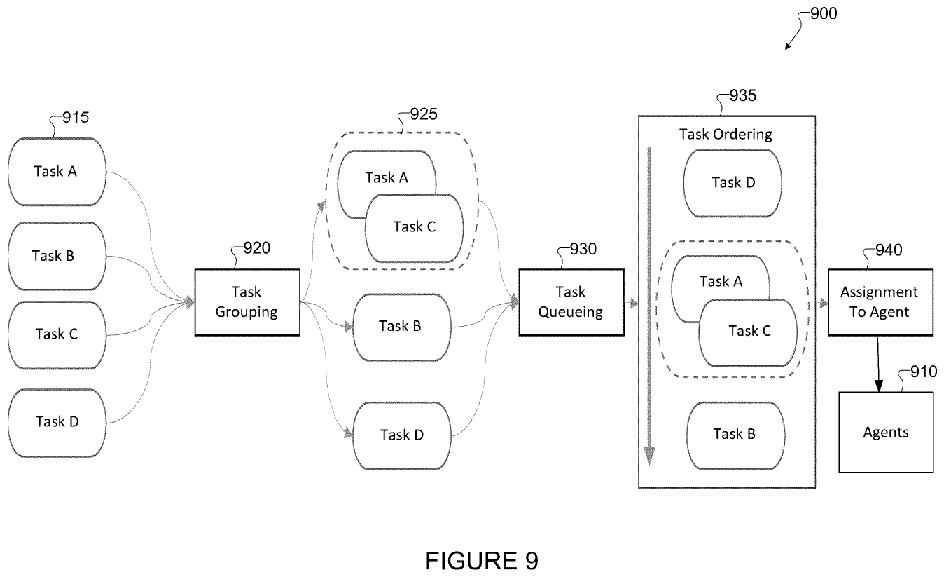

FIG. 9 illustrates an example framework 900 for distribution of tasks between agents based on time prioritization according to this disclosure. Many components of the framework 900 are the same as or similar to corresponding components of the framework 200 of FIG. 2. For ease of explanation, the framework 900 is described as being implemented using one or more components of the network configuration 100 of FIG. 1 described above, such as one or more instances of the electronic device 101 and/or the server 106. However, this is merely one example, and the framework 900 could be implemented using any other suitable device(s) and in any other suitable system(s).

As shown in FIG. 9, the framework 900 includes a group of tasks 915, which can be similar to the interactions 215 in the sense that the tasks 915 require attention by one or more agents 910. Here, the speed of distribution of the tasks 915 to agents 910 may not be a high priority. Instead, the framework 900 allows similar tasks 915 to be grouped over time so that the similar tasks 915 can be handled together by one agent 910. Example use cases for the framework 900 can include an information technology (IT) ticketing system, a package delivery system, a software development platform, and the like.

In FIG. 9, certain tasks 915 that are similar can be grouped together in a task grouping operation 920. The result includes at least one task group 925, which includes Task A and Task C (based on the fact that Task A and Task C are similar). The task group(s) 925 and the remaining tasks 915 are placed in a task queue 935 using a task queueing operation 930. In the task queue 935, the tasks 915 and task groups 925 are ordered based on a time priority for completion (such as critical, high priority, medium priority, and low priority). Once the tasks 915 and task groups 925 are ordered in the task queue 935, the tasks 915 and task groups 925 can be assigned to the agents 910 using an assignment operation 940.

Although FIG. 9 illustrates one example of a framework 900 for distribution of tasks between agents based on time prioritization, various changes may be made to FIG. 9. For example, while the framework 900 is described as including specific sequences of operations, various operations described with respect to FIG. 9 could overlap, occur in parallel, occur in a different order, or occur any number of times (including zero times). Also, the specific operations shown in FIG. 9 are examples only, and other techniques could be used to perform each of the operations shown in FIG. 9.

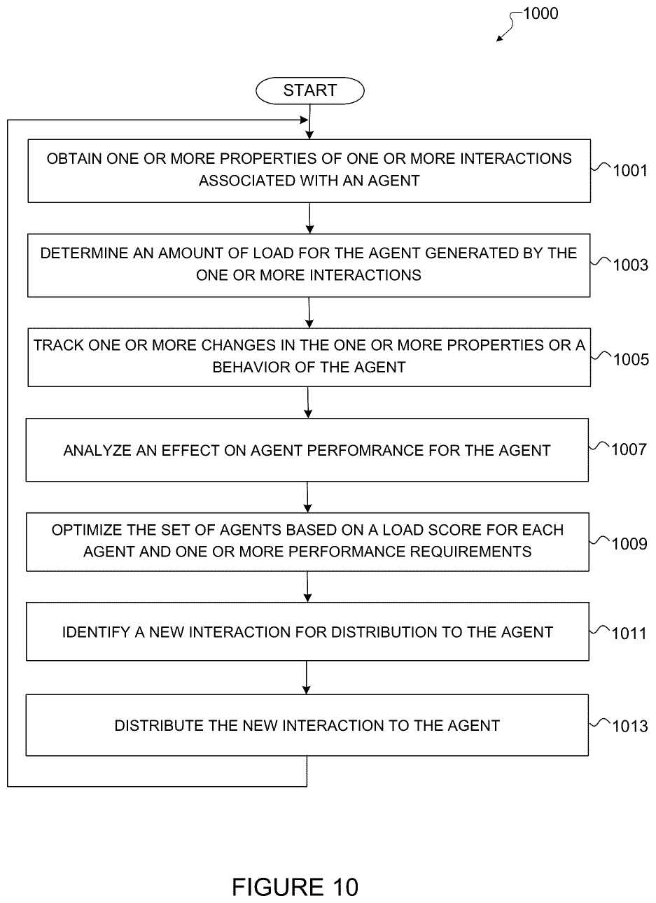

FIG. 10 illustrates an example method 1000 for distribution of interactions between agents based on load according to this disclosure. For ease of explanation, the method 1000 shown in FIG. 10 is described as being performed using the server 106 shown in FIG. 1, which can implement the framework 200 shown in FIG. 2. However, the method 1000 shown in FIG. 10 could be used with any other suitable device(s) an in any other suitable system(s).

As shown in FIG. 10, one or more properties of one or more interactions associated with an agent are obtained at step 1001. This could include, for example, the server 106 performing the operation 235 to obtain information about the interactions 215 associated with one of the agents 210a-210n. An amount of load for the agent generated by the one or more interactions is determined based on the one or more properties of the one or more interactions at step 1003. This could include, for example, the server 106 performing the operation 220 to determine the current interaction load for the agent 210a-210n as a result of the interactions 215. One or more changes in the one or more properties or a behavior of the agent is tracked at step 1005. This could include, for example, the server 106 performing the operation 220 to track changes in the properties of the interactions 215 or the behavior of the agent 210a-210n.

An effect on agent performance for the agent is analyzed based on (i) the amount of load for the agent and (ii) the one or more changes in the one or more properties or the behavior of the agent at step 1007. This could include, for example, the server 106 performing the operation 225 to analyze the effects on the performance of each agent 210a-210n based on the amount of load for each agent 210a-210n, changes in properties of the interactions 215, or the behavior of each agent 210a-210n. The agent set is optimized based on a load score for each agent and one or more performance requirements for the agent set at step 1009. This could include, for example, the server 106 performing the operation 650 to optimize the set of agents 210a-210n using the load scores 222 of the agents 210a-210n and one or more system performance requirements 655.

A new interaction for distribution to the agent is identified at step 1011. This analysis can be based on analyzing agent performance data for an agent set including the agent, where the agent performance data for the agent set includes the effect on agent performance for the agent. This could include, for example, the server 106 performing the operation 240 to identify a new interaction 230 for distribution to the agent 210a-210n. Once identified, the new interaction can be distributed to an agent at step 1013. This could include, for example, the server 106 performing the operation 240 to distribute the new interaction 230 to the agent 210a-210n.

As shown in FIG. 10, the method 1000 can be performed repeatedly or continuously in order to process new interactions 230, interactions 215 already in progress, and loads of new or existing agents 210a-210n.

Although FIG. 10 illustrates one example of a method 1000 for distribution of interactions between agents based on load, various changes may be made to FIG. 10. For example, while shown as a series of steps, various steps in FIG. 10 could overlap, occur in parallel, occur in a different order, or occur any number of times (including zero times).

As described above, the disclosed embodiments can provide a variety of advantageous benefits depending on the implementation. As an example, the disclosed embodiments facilitate load balancing when there are moments of high peak incoming interactions. In systems where the number of agents is limited and the number of simultaneous interactions is much higher, the disclosed embodiments enable the proper distribution of every incoming interaction, which can reduce waiting times for any new customers or clients.

As another example, the disclosed embodiments enable knowledge and capabilities optimization by keeping track of agent performance during interactions. Based on the significant data that gets collected for each interaction, the content and results of the interactions can be used to better understand how each agent performs. For example, comparing agent interactions involving answering questions about a television versus agent interactions involving answering questions about a soundbar can reveal delays or bottlenecks in responses by a specific agent for specific interaction types. Accumulating this information in real time allows the system to optimize which agents receive certain interactions when possible. This information can also be used to identify training opportunities that might be needed by the agents to be able to provide improved or optimal support.

As yet another example, the disclosed embodiments enable improved overall system performance understanding. For example, in customer support platforms that have agents always available (such as 24 hours/day, seven days a week) to handle customer interactions, understanding how different agents perform when the platform is busier or less busy becomes important for scheduling agents through different times of the day. The ability of the disclosed embodiments to track performance and busyness of the system down to the agent level provides key information for system administrators and managers to distribute available resources.

Note that the operations and functions shown in or described with respect to FIGS. 2 through 10 can be implemented in an electronic device 101, 102, 104, server 106, or other device(s) in any suitable manner. For example, in some embodiments, the operations and functions shown in or described with respect to FIGS. 2 through 10 can be implemented or supported using one or more software applications or other software instructions that are executed by the processor 120 of the electronic device 101, 102, 104, server 106, or other device(s). In other embodiments, at least some of the operations and functions shown in or described with respect to FIGS. 2 through 10 can be implemented or supported using dedicated hardware components. In general, the operations and functions shown in or described with respect to FIGS. 2 through 10 can be performed using any suitable hardware or any suitable combination of hardware and software/firmware instructions. Also, the functions shown in or described with respect to FIGS. 2 through 10 can be performed by a single device or by multiple devices.

Although this disclosure has been described with reference to various example embodiments, various changes and modifications may be suggested to one skilled in the art. It is intended that this disclosure encompass such changes and modifications as fall within the scope of the appended claims.

What is claimed is:

1. A method comprising:
obtaining, using at least one processing device of an electronic device, one or more properties of one or more interactions associated with an agent;
determining, using the at least one processing device, an amount of load for the agent generated by the one or more interactions based on the one or more properties of the one or more interactions;
tracking, using the at least one processing device, one or more changes in the one or more properties or a behavior of the agent;
analyzing, using the at least one processing device, an effect on agent performance for the agent based on (i) the amount of load for the agent and (ii) the one or more changes in the one or more properties or the behavior of the agent; and
identifying, using the at least one processing device, a new interaction for distribution to the agent based on analyzing agent performance data for an agent set including the agent, wherein the agent performance data for the agent set includes the effect on agent performance for the agent.

2. The method of claim 1, wherein identifying the new interaction for distribution to the agent comprises:
obtaining the new interaction from a queue of interactions to assign;
determining a load level of the new interaction; and
selecting the agent from a group of available agents in the agent set based on the load level of the new interaction, the group of available agents being sorted based on the agent performance data.

3. The method of claim 1, wherein the one or more properties of the one or more interactions include at least one of: a type of the interaction, data collected during the interaction, and one or more behaviors of a customer during the interaction.

4. The method of claim 1, wherein determining the amount of load for the agent comprises:
determining a load score for the agent based on the one or more properties of the one or more interactions.

5. The method of claim 1, wherein:
the agent set further includes at least one other agent; and
the agent performance data for the agent set includes information associated with agent performance for the at least one other agent.

6. The method of claim 5, further comprising:
optimizing the agent set based on a load score for each agent and one or more system performance requirements.

7. The method of claim 1, wherein the agent is a support agent.

8. An electronic device comprising:
at least one processing device configured to:
obtain one or more properties of one or more interactions associated with an agent;
determine an amount of load for the agent generated by the one or more interactions based on the one or more properties of the one or more interactions;
track one or more changes in the one or more properties or a behavior of the agent;
analyze an effect on agent performance for the agent based on (i) the amount of load for the agent and (ii) the one or more changes in the one or more properties or the behavior of the agent; and
identify a new interaction for distribution to the agent based on analyzing agent performance data for an agent set including the agent, wherein the agent performance data for the agent set includes the effect on agent performance for the agent.

9. The electronic device of claim 8, wherein, to identify the new interaction for distribution to the agent, the at least one processing device is configured to:
obtain the new interaction from a queue of interactions to assign;
determine a load level of the new interaction; and
select the agent from a group of available agents in the agent set based on the load level of the new interaction, the group of available agents being sorted based on the agent performance data.

10. The electronic device of claim 8, wherein the one or more properties of the one or more interactions include at least one of: a type of the interaction, data collected during the interaction, and one or more behaviors of a customer during the interaction.

11. The electronic device of claim 8, wherein, to determine the amount of load for the agent, the at least one processing device is configured to determine a load score for the agent based on the one or more properties of the one or more interactions.

12. The electronic device of claim 8, wherein:
the agent set further includes at least one other agent; and
the agent performance data for the agent set includes information associated with agent performance for the at least one other agent.

13. The electronic device of claim 12, wherein the at least one processing device is further configured to optimize the agent set based on a load score for each agent and one or more system performance requirements.

14. The electronic device of claim 8, wherein the agent is a support agent.

15. A non-transitory machine-readable medium containing instructions that when executed cause at least one processor of an electronic device to:
obtain one or more properties of one or more interactions associated with an agent;
determine an amount of load for the agent generated by the one or more interactions based on the one or more properties of the one or more interactions;
track one or more changes in the one or more properties or a behavior of the agent;
analyze an effect on agent performance for the agent based on (i) the amount of load for the agent and (ii) the one or more changes in the one or more properties or the behavior of the agent; and
identify a new interaction for distribution to the agent based on analyzing agent performance data for an agent set including the agent, wherein the agent performance data for the agent set includes the effect on agent performance for the agent.

16. The non-transitory machine-readable medium of claim 15, wherein the instructions that when executed cause the at least one processor to identify the new interaction for distribution to the agent comprise:
instructions that when executed cause the at least one processor to:
obtain the new interaction from a queue of interactions to assign;
determine a load level of the new interaction; and
select the agent from a group of available agents in the agent set based on the load level of the new interaction, the group of available agents being sorted based on the agent performance data.

17. The non-transitory machine-readable medium of claim 15, wherein the one or more properties of the one or more interactions include at least one of: a type of the interaction, data collected during the interaction, and one or more behaviors of a customer during the interaction.

18. The non-transitory machine-readable medium of claim 15, wherein the instructions that when executed cause the at least one processor to determine the amount of load for the agent comprise:
instructions that when executed cause the at least one processor to determine a load score for the agent based on the one or more properties of the one or more interactions.

19. The non-transitory machine-readable medium of claim 15, wherein:
the agent set further includes at least one other agent; and
the agent performance data for the agent set includes information associated with agent performance for the at least one other agent.

20. The non-transitory machine-readable medium of claim 19, wherein the instructions when executed further cause the at least one processor to optimize the agent set based on a load score for each agent and one or more system performance requirements.
